(19) United States
(12) Patent Application Publication
(10) Pub. No.: US 2012/0102450 A1
(43) Pub. Date: Apr. 26, 2012

(54) METHOD AND SYSTEM FOR DETERMINING PERFORMANCE PARAMETERS OF SOFTWARE PROJECT BASED ON SOFTWARE-ENGINEERING TOOLS USAGE

(75) Inventor: Naresh Choudhary, Thane (IN)

(73) Assignee: INFOSYS TECHNOLOGIES LIMITED, Bangalore (IN)

(21) Appl. No.: 13/073,241

(22) Filed: Mar. 28, 2011

(30) Foreign Application Priority Data
Oct. 22, 2010 (IN) 3130/CHE/2010

(51) Int. Cl. G06F 9/44

(52) U.S. Cl. 717/101

(57) ABSTRACT

A method and system have been disclosed for determining one or more performance parameters of a project. Various examples of the performance parameters of the project may include productivity, efficiency, and quality. The method described above includes defining one or more lifecycle stages of the project. Examples of the lifecycle stages of the project may include requirement analysis, high-level design, detailed design, build, integration test, system test, documentation, acceptance, installation, and post implementation. Further, the method includes receiving details of one or more tools being used for each lifecycle stages of the project. The method further includes assigning a score based on the one or more tools being used for the project. Further, the method also includes automatically calculating a value based on the assigned score. Thereafter, the performance parameters of the project are determined based on the calculated value.

### FIELD OF THE INVENTION

The present invention relates, in general, to the Software Engineering (SE) field. More specifically, the invention relates to method and system for determining performance parameters of software project based on software-engineering tools use.

### BACKGROUND OF THE INVENTION

Software Engineering (SE) is a field related to the design and development of high-quality software and is evolved out of the need for managing the increased size and complexity of software projects. In today's business environment, project management has become important for many industries and organizations, especially for software organizations. Accordingly, Software Engineering Project Management (SEPM) has gained importance over the past few years. In general, project management is a process that uses a systematic and disciplined approach to develop software. The project management enables a leader or a project manager to focus on priorities, track and measure performances, overcome challenges and issues, and achieve higher performance in terms of quality and productivity.

Various lifecycle stages of the project management include developing a project plan, identifying project goals and objectives, identifying a methodology to achieve the goals, determining the scope of the project, and implementing project components in a timely manner. To execute various phases of the project, one or more tools corresponding to various programming languages may be employed. Examples of tools corresponding to the programming languages—Visual Basic and Java—include Rational Rose and Influx, respectively.

From the start of the project to its completion, various activities associated with each lifecycle stages are executed. For instance, during the lifecycle stage of developing a project plan, a plan or process is prepared by the project manager to execute all the steps required for the project completion. Similarly, in the lifecycle stage of identifying project goals, goals such as, customer satisfaction and on-time delivery are identified. After the execution of the various lifecycle stages of the project, one of the challenging tasks for the project manager is to determine the performance of the project and to identify its performance gaps and corrective measures. In general, the performance of the project depends on the performance of a team, which in turn also greatly depends on the extent of the use of tools in the project. Since the performance of the project is directly related to the use of tools, it is highly preferred to use these tools in almost every software organization. However, there are chances that the team involved in the project does not use tools due to various reasons, such as team's lack of awareness about the tools. Accordingly, quality and productivity (or performance) of the project falls down because the tools are not being used in the project. Therefore, the use of tools in all phases of the project is recommended to enhance the performance of the project.

There are no standardized solutions which help determine the usage of tools in projects. In some cases, the usage of tools is tracked manually which involves a lot of effort and time. Some large organizations have developed in-house mechanisms which focus on determining the use of tools separately for each unit in an organization. For example, the use of tools may be determined separately for “development unit” and for “quality unit” of the organization. In other words, there is no way of tracking and comparing the use of tools across the organization. Accordingly, the method used to determine the use of tools in various projects may differ across various units in the organization. Hence, there is no uniform method of computing the use of tools across the organization. Due to this limitation, performance of a project in one unit cannot be compared with the performance of a project in another unit. Similarly, there is no standard approach to evaluate the use of tools for different organizations.

In light of the foregoing discussion, there is a need for a method and system to evaluate the usage of tools in an organization. The method and system should enable an automatic process for determining/computing the usage of tools in various software projects, thereby making it easy for the project manager to determine performance parameters of the project. Further, there exists a need for introducing a unified solution/approach to compute the usage of tools in different projects across various units in the organization. Accordingly, performance of a project in one unit can be compared with the performance of a project in another unit of the organization.

### SUMMARY OF THE INVENTION

The present invention describes a method for determining one or more performance parameters of a project. The performance parameters of the project may include quality, productivity, and efficiency. The method includes defining one or more lifecycle stages of the project. Various lifecycle stages of the project, at a broader level, may include requirement analysis, design, and implementation. The method further includes receiving details of one or more tools being used for each lifecycle stages of the project. Further, the method includes assigning a score based on the tools being used for the project. The assignment of a score includes assigning a first score to each lifecycle stage of the project when a corresponding tool is used for each lifecycle stages of the project. The assigning of a score further includes assigning a second score to each valid lifecycle stages of the project when no tool is used for a corresponding lifecycle stage of the project. The valid lifecycle stages of the project refer to the stages which are essentially required for the completion of the project; however, no tool is being used for that lifecycle stage in the project. Thereafter, a value based on the assigned scores is automatically calculated. Based on the calculated value, the performance parameters of the project are determined.

The present invention describes an Integrated Project Management (IPM) system for determining one or more performance parameters of a project. The IPM is configured to define one or more lifecycle stages of the project. The IPM is further configured to receive details of one or more tools being used for each lifecycle stages of the project. Further, the IPM is configured for assigning a score based on the one or more tools being used for the project. The assignment of the score includes assigning a first score to each lifecycle stages of the project when a corresponding tool is used for each lifecycle stages of the project. The assignment of the score further includes assigning a second score to each valid lifecycle stages of the project when no tool is used for a corresponding lifecycle stage of the project. The valid lifecycle stages of the project refer to the stages which are essentially required for the completion of the project. Furthermore, the IPM is configured for automatically calculating a value based on the assigned scores. Moreover, the IPM is configured for determining the performance parameters of the project based on the calculated value.

Additionally, the present invention describes a Computer Program Product (CPP) for determining one or more performance parameters of a project. The performance parameters of the project may include quality, productivity, and efficiency. The CPP includes a program instruction means for defining one or more lifecycle stages of the project. Various lifecycle stages of the project may include requirement analysis, design, and implementation. Further, the CPP includes a program instruction means for receiving details of one or more tools being used for each lifecycle stages of the project. The CPP further includes a program instruction means for assigning a score based on the tools being used for the project. The program instruction means corresponding to the assignment of a score includes a program instruction means for assigning a first score to each lifecycle stages of the project when a corresponding tool is used for each lifecycle stages of the project. Further, the program instruction means corresponding to the assignment of a score includes a program instruction means for assigning a second score to each valid lifecycle stages of the project when no tool is used for a corresponding lifecycle stage of the project. Moreover, the CPP includes a program instruction means for automatically calculating a value based on the assigned score. In addition to the above, the CPP includes a program instruction means for determining the performance parameters of the project based on the calculated value.

### BRIEF DESCRIPTION OF THE DRAWINGS

Various embodiments of the invention will hereinafter be described in conjunction with the appended drawings provided to illustrate, and not to limit, the invention, wherein like designations denote like elements, and in which:

FIG. 1 illustrates an environment in which various embodiments of the invention may be practiced, in accordance with an embodiment of the invention;

FIG. 2 is a flow diagram for determining one or more performance parameters of a project, in accordance with an embodiment of the invention;

FIG. 3 is an exemplary depiction of an Integrated Project Management (IPM) platform for receiving details of effort estimate for each lifecycle stages of a project, in accordance with an embodiment of the invention;

FIG. 4 is an exemplary depiction of an IPM platform for receiving details of technology being used for each lifecycle stages of a project, in accordance with an embodiment of the invention;

FIG. 5 is an exemplary depiction of an IPM platform for receiving details of one or more tools being used for each lifecycle stages of a project, in accordance with an embodiment of the invention;

FIG. 6 is an exemplary depiction of an IPM platform illustrating a value of Tools Usage Index (TUI), in accordance with an embodiment of the invention; and

FIG. 7 is another exemplary depiction of an IPM platform depicting a value of Tools Usage Index (TUI), in accordance with an embodiment of the present invention.

### DETAILED DESCRIPTION

Broadly, the present invention relates to performance measurement of a project. Performance measurement primarily aids organizations to understand how various processes or practices led to success or failure in the past. Further, it also helps in understanding how these processes or practices can lead to improvements in future projects. More specifically, the present invention describes a method and a system for determining one or more performance parameters of a project. The performance parameters of the project are determined by tracking the usage of tools in the project. Various examples of the performance parameters may include, but are not limited to, quality, productivity, efficiency, customer satisfaction, effort, cycle time, and defect rate. Once the performance parameters related to the project are determined, these are compared with performance targets to identify performance gaps, if any. These gaps are analyzed to identify corrective actions or to enhance skills for future projects.

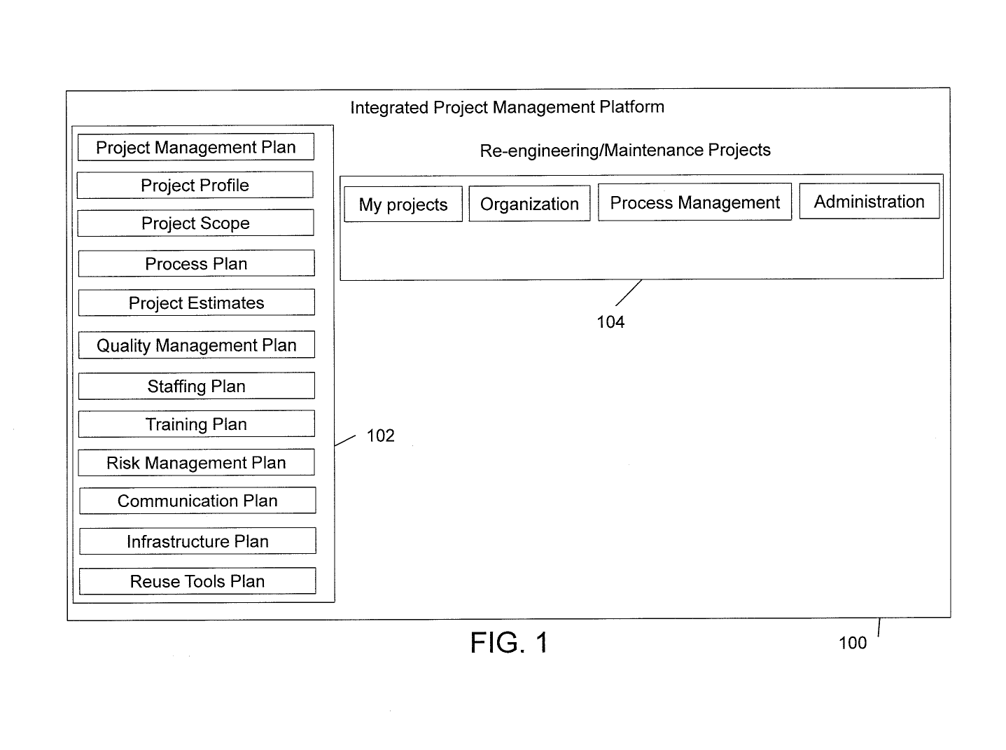

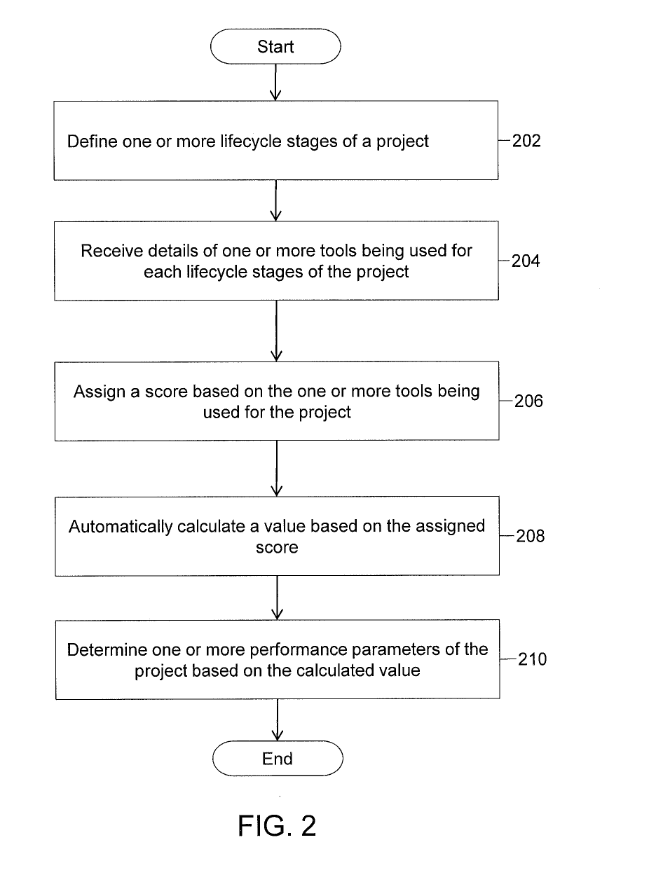

FIG. 1 illustrates an environment in which various embodiments of the invention may be practiced, in accordance with an embodiment of the invention. To describe the system elements illustrated in FIG. 1, references will be made to FIG. 2. It will be apparent to those skilled in the art that the steps executed by the system elements can be applicable to any other embodiment of the present invention.

Environment, as depicted in FIG. 1, corresponds to an Integrated Project Management (IPM) platform 100. IPM platform 100 is a Web-based tool, including advanced planning, tracking, analytical, and reporting features. Further, IPM platform 100 facilitates an effective, efficient, enterprise-level project, and program management. Also, IPM platform 100 provides a robust mechanism to implement one or more processes, such as, but is not limited to, Application Development and Maintenance, and Testing, and the like. In addition to the above, IPM platform 100 provides the senior management of an organization with information on the health of the projects currently underway so that right actions can be initiated in time, in case of any issues.

IPM platform 100, as depicted in FIG. 1, includes an exemplary section 102 illustrating various processes to be executed while implementing any project. Examples of various processes of the project may include, but are not limited to, Project Management Plan, Project Profile, Project Scope, Process Plan, Project Estimates, Quality Management Plan, Staffing Plan, Training Plan, Risk Management Plan, Communication Plan, Infrastructure Plan, and Reuse Tools Plan. These processes facilitate managing and tracking of projects, for example, software projects. Further, IPM platform 100 also facilitates additional options, as shown in an exemplary section 104, for managing projects, such as My Projects, Organization, Process Management, and Administration.

For the one ordinary skilled in the art, it is apparent that the processes described above are well known in the art.

IPM platform 100, as mentioned above, is used to determine performance parameters of a project. Various types of projects are, software development projects, software maintenance projects, and the like. The performance parameters of the project are determined by tracking the usage of tools and the process of tracking the usage of tools has been described in detail in conjunction with FIG. 2. Once, the usage of tools is determined, outcome measures are identified. In other words, the more is the usage of tools in the project; the better is the performance of the project. Accordingly, the probability of achieving goals or objectives in the project is significantly high.

FIG. 2 is a flow diagram for determining one or more performance parameters of a project, in accordance with an embodiment of the invention. To describe the method illustrated in FIG. 2, references will be made to FIG. 1. It will be apparent to those skilled in the art that the method can be applicable to any other embodiment of the present invention.

At step 202, one or more lifecycle stages of a project are defined. The lifecycle stages of the project correspond to logical sequences of activities to accomplish project goals or objectives. The lifecycle stages of the project are defined by a project manager according to various requirements of the project or the project goals to be achieved.

Examples of various types of projects may include, but are not limited to, software development projects, software re-engineering projects, documentation projects, and software maintenance projects.

In an exemplary embodiment of the present invention, various lifecycle stages of the project are defined. According to this embodiment, various lifecycle stages of the project may include, but are not limited to, requirement analysis, high-level design, detailed design, coding, unit testing, integration testing, and system testing.

In accordance with another embodiment of the invention, the lifecycle stages of the project may include, but are not limited to, requirement analysis, planning, designing, coding, integration testing, and delivery.

In accordance with yet another embodiment of the invention, the lifecycle stages of the project may include, but are not limited to, requirement analysis, design, and implementation.

In accordance with another further embodiment of the invention, the lifecycle stages of the project may include, but are not limited to, initiation, planning, execution, and controlling, and closure.

In addition to the embodiments above, the lifecycle stages of the project may also include, requirement analysis, high-level design, detailed design, build, integration testing, system test, documentation, acceptance, installation, and post implementation.

Those ordinarily skilled in art can appreciate that various types of projects and lifecycle stages of the projects, mentioned above, are exemplary in nature and are used to facilitate the description of the present figure. There can be various other types of projects and lifecycle stages associated with the projects.

Once lifecycle stages of the project have been defined at step 202, details of effort estimate required for each lifecycle stages of the project is received. The details of the effort estimate are received from the project manager. The effort estimate required for each lifecycle stages may be in terms of number of hours, number of days, and the like. Further, the effort estimate required for each lifecycle stages of the project may vary with the complexity of the project.

After receiving the effort estimate for each lifecycle stages, effort in terms of percentage may be calculated, if required. Thereafter, details of one or more programming languages being used for each lifecycle stages of the project are received from the project manager. For instance, one lifecycle stage of the project may use a programming language such as Visual Basic (VB) and a second lifecycle stage may use VB.Net, and so forth. Accordingly, each lifecycle stages of the project may use different programming languages depending upon the scope and requirement of the project.

Various examples of the programming languages may include, but are not limited to, Visual Basic (VB), Visual FoxPro, VB.Net, Java, JavaScript, Job Control Language (JCL), C, C++, C# (ASP.Net), Perl, Hypertext Preprocessor (PHP), HyperText Markup Language (HTML), Unified Modeling Language (UML), Extensible Markup Language (XML), Smalltalk, Pascal, Common Business-Oriented Language (Cobol), Formula Translator (Fortran), Structured Query Language (SQL), and Oracle.

Referring to the description above, after receiving details of the programming languages, step 204 is performed. At step 204, details of one or more tools being used for each lifecycle stages of the project are received from the project manager. The tools described here correspond to various platforms for executing an activity associated with each lifecycle stages of the project.

In accordance with an embodiment of the present invention, it can be assumed that the project manager wishes to use one or more standard tools in the project. The standard tools correspond to various tools recommended by the organization to be used in the project. Accordingly, the project manager selects the tools from a predefined list of standard tools available in a project management platform, such as IPM platform 100.

In accordance with another embodiment of the present invention, it can be assumed that the project manager wishes to use one or more non-standard tools in the project. The non-standard tools correspond to various tools, which may not be recommended by the organization but can be used for the project. Accordingly, the project manager adds the tools to the project management platform, such as IPM platform 100, which he/she wishes to use in the project.

The tools mentioned above are the platforms corresponding to various programming languages. For instance, tools corresponding to programming language VB.Net may include Microsoft VSTS, Microsoft VSTS Nunit, and the like. Similarly, tools corresponding to programming language Java may include, but are not limited to, Influx, Rational Functional Tester, and Rational Performance Tester. Similarly, there can be many more predefined tools corresponding to various programming languages.

In general, various examples of the tools may include, but are not limited to, Rational Rose, Rational Functional Tester, Eclipse, Rational Application Developer (RAD), Rational Purify Plus, Radien Profiler, Junit, Parasoft JTest, Microsoft VSTS, Visual Studio, Quest TOAD, Parasoft C++ Test, Rational Test Manager, and Rational Robot.

After receiving the details of the tools, step 206 is performed. At step 206, a score based on the tools being used for the project is assigned. In an exemplary embodiment of the present invention, it can be assumed that the tools used for the project, such as software development project, are Rational Rose, and RAD, accordingly, a score of 10 is assigned. The score may have a value varying from 0 to 100.

Step 206 described above includes assigning a first score to each lifecycle stage of the project when a tool corresponding to the lifecycle stage is being used in the project. Further, the step of assigning a score includes assigning a second score to each valid lifecycle stages of the project when no tool is being used for a corresponding lifecycle stage of the project. In this manner, a score is assigned to each lifecycle stages of the project based on the tools being used for the project.

After assigning the score to each lifecycle stages, at step 208, a value is calculated automatically based on the assigned score. The value is calculated by applying predefined mathematical operators, such as division, multiplication, addition, subtraction, or a combination of these operators.

In accordance with a preferred embodiment of the invention, the value is obtained by using the division operator. The obtained value is further multiplied by a predefined number, such as 100, to obtain a desired value. The desired value obtained here corresponds to a Tools Usage Index (TUI). The TUI can have a value varying from 0% to 100%, indicating the level of tools use. Further, the TUI can be a part of a milestone report or other metrics report, which can be generated, for example, every 45 days.

In an exemplary embodiment of the present invention, the value or the TUI can be calculated by using an equation:

Tools Usage Index=(a/b)*100

where, numerator “a”=Sum of scores of each tool used; and denominator “b”=sum of scores of each tool used+score assigned to each valid lifecycle stage when no tool is used.

Thereafter, at step 210, the performance parameters of the project are determined based on the calculated value. The performance parameters of the project may include, but are not limited to, quality, productivity, efficiency, customer satisfaction, effort, cycle time, and defect rate. For example, the value closer to 100 defines that the project has a high quality and productivity, and thus goals of the project are achieved successfully. Accordingly, the project is considered successful, and the scope of improvement in the project is less.

In an example, it can be considered that the TUI obtained is low (0-59%), which shows that the project may have a low quality and productivity. This further illustrates that the goals of the project may not be achieved successfully. Accordingly, corrective measures, such as organizing training and awareness programs on engineering tools for the team and implementing extensive usage of tools, can be taken for future projects.

In another example, it can be considered that the TUI obtained is high (81-100%), which shows that the project has a good quality and productivity, and the goals of the project may be achieved successfully. In such cases, a detailed analysis is done to find out the gaps where improvements can be brought by implementing tools. Similarly, there can be scenarios where some tools are already in use. However, the score is still in the lower range. For such cases, a feasibility study needs to be done to add tools, in addition to the ones already in place, to improve the overall quality and productivity.

In addition to this, the process described above for determining the performance parameters of the project for all units such as quality and testing, can be employed. Accordingly, performance of a project of one unit can be compared with performance of a project of another unit, if required. Similarly, performance of various projects of one organization can be compared with the performance of projects of another organization.

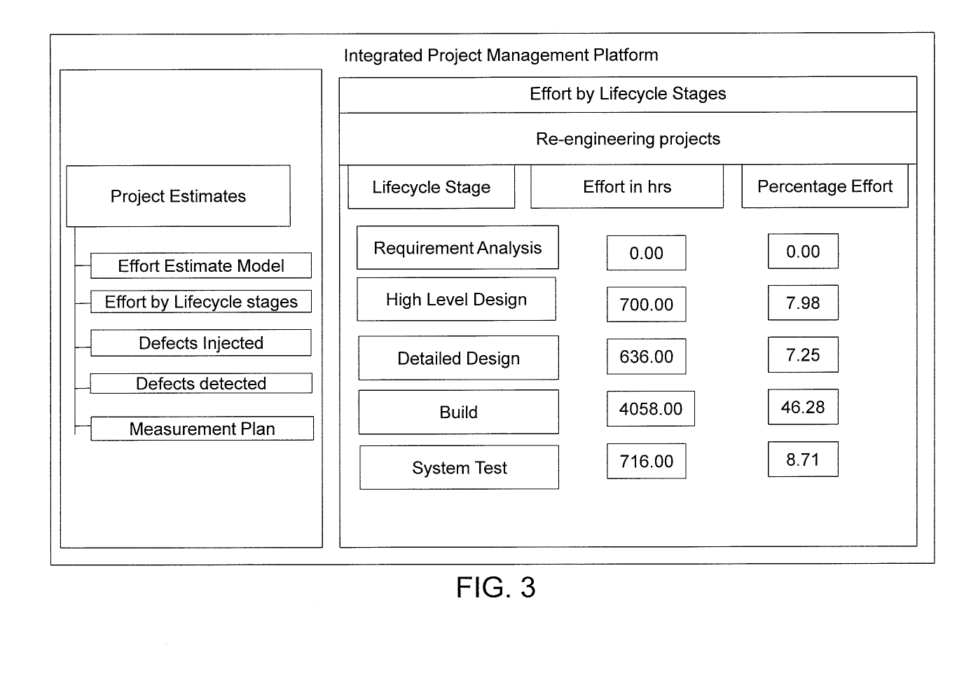

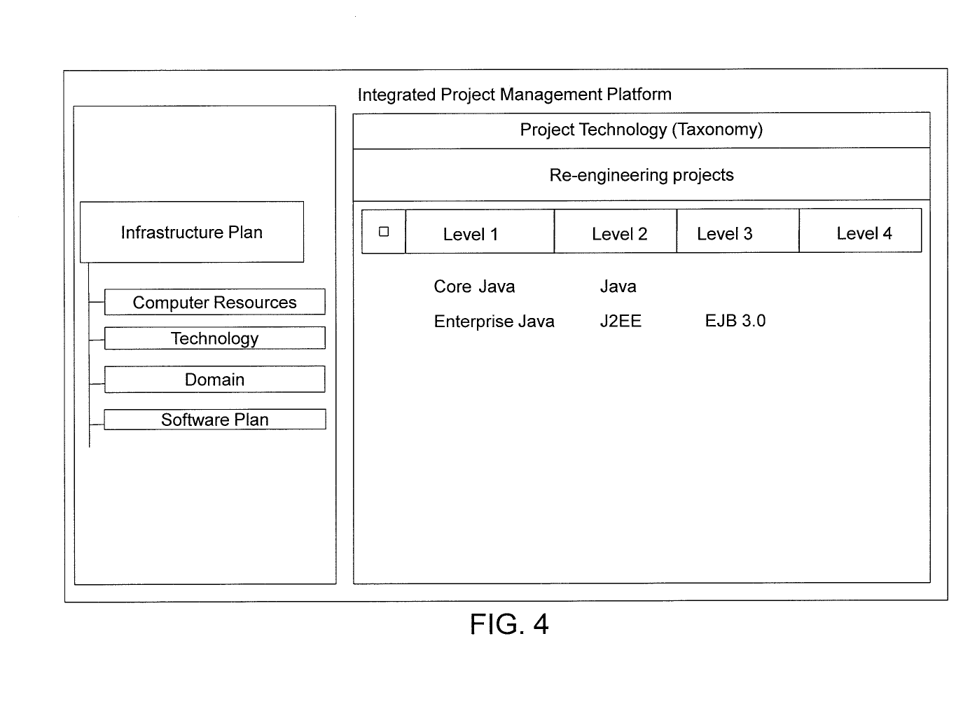

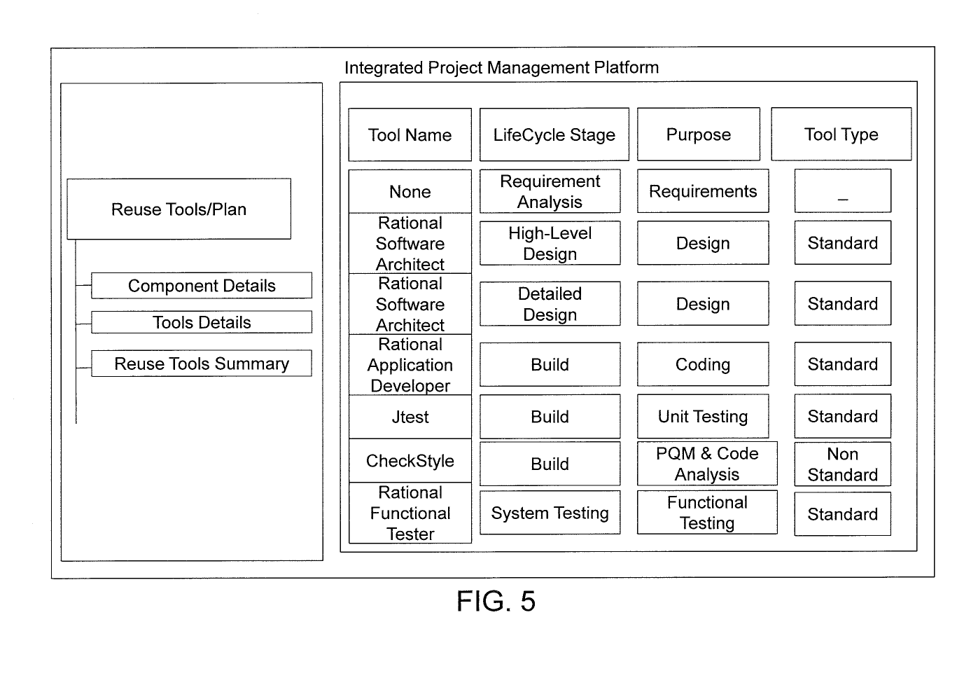

The invention has been explained with the help of an exemplary embodiment. In this exemplary embodiment, it can be assumed that various lifecycle stages of the software development project are requirement analysis, high-level design, detailed design, build, and integration testing. The lifecycle stages of the project are defined by the project manager. After defining the lifecycle stages of the project, details of effort estimate required for each of the lifecycle stages are input by the project manager through the IPM platform as depicted in FIG. 3. According to FIG. 3, an effort estimate required for requirement analysis, high-level design, detailed design, build, and system test, is 0.00 hrs, 700.00 hrs, 636.00 hrs, 4058.00 hrs, and 716.00 hrs, respectively. After receiving the details of the effort estimate, details of the technology to be used in the project are received from the project manager. For instance, the technology input by the project manager to be used in the project is Java, J2ee, and EJB as shown in FIG. 4. Thereafter, details of the one or more tools associated with the technology are received. As shown in FIG. 5, the tools used for each lifecycle stages and corresponding sub-stages, referred to as “purpose”, mentioned above are Rational Software Architect, Rational Application Developer, Jtest, checkStyle, and Rational Functional Tester. No tools are used for Requirement analysis. Further, FIG. 5 also describes the purpose of using a tool for a particular lifecycle stage. For example, FIG. 5 illustrates that Rational Software Architect tool is being used for “designing purpose”, whereas the JTest tool is used for “build” purpose and so on.

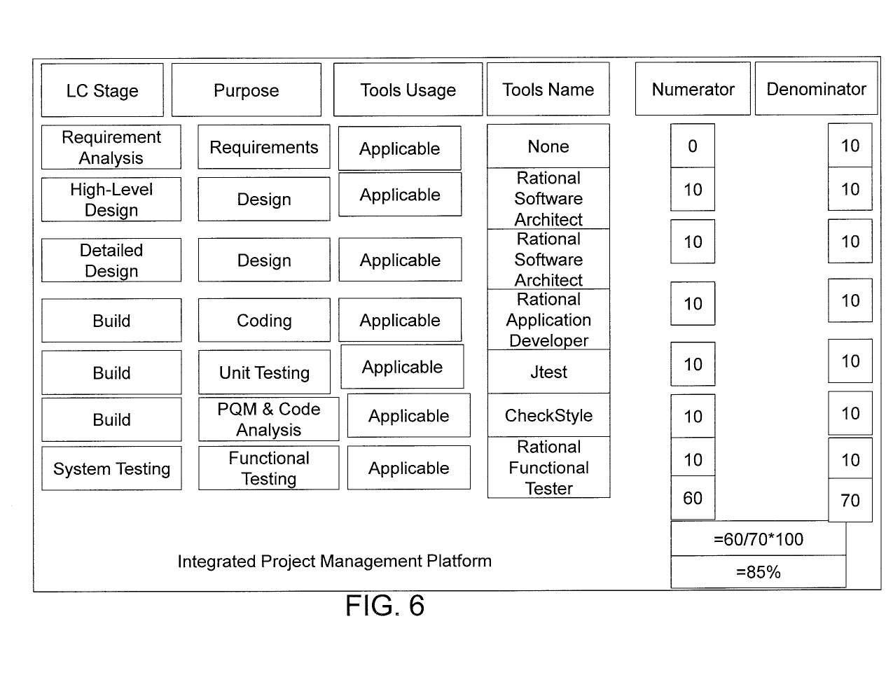

Once the details of the tools are received, a score is assigned to each of the lifecycle stages/purposes of the project as shown in FIG. 6. According to FIG. 6 and equation described above, a score of “0” is assigned to the numerator since no tool is used for the requirement analysis lifecycle stage for requirements purpose. Further, since requirement analysis is a valid lifecycle stage of the project, a score of 10 is assigned to the denominator. Similarly, a score is assigned to the numerator and denominator corresponding to each life cycle stages of the project as mentioned above and has been illustrated in FIG. 6.

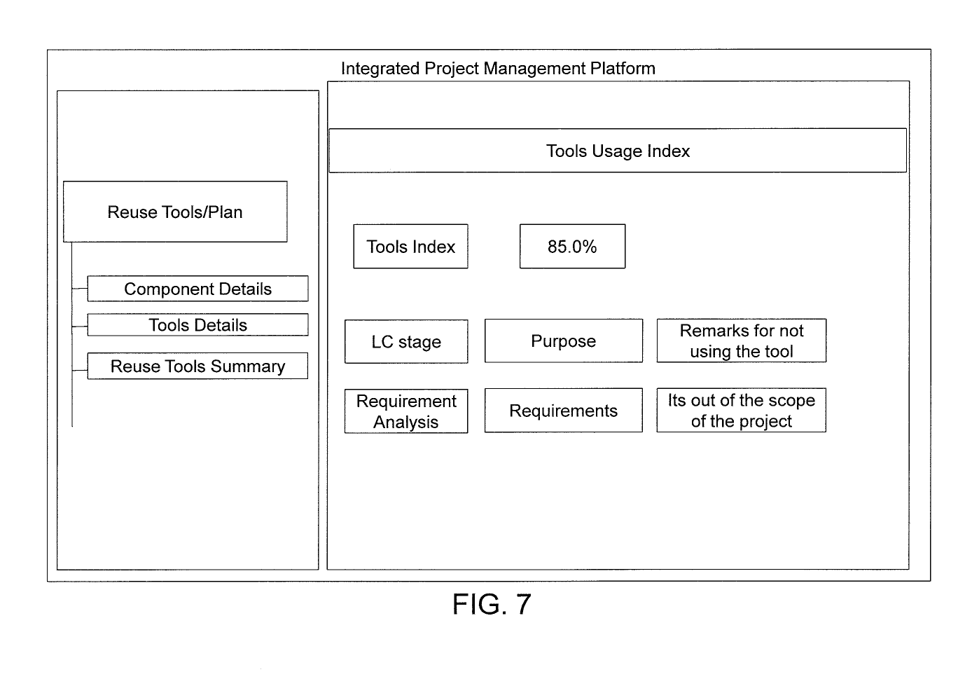

Thereafter, a value or the TUI is calculated based on the score assigned as shown in FIG. 6. To obtain the desired value, a step of adding the score forming a part of the numerator for each lifecycle stages is performed. Similarly, the score forming a part of the denominator is also added. Thereafter, the numerator is divided by the denominator and further the result is multiplied by 100 as shown in FIG. 6. Finally, the value obtained after calculation is 85% as shown in FIGS. 6 and 7. In other words, the value can be obtained by applying an equation similar to the one described above.

The calculated value corresponds to TUI. The TUI is a measure of quality, productivity, and efficiency of the project. Based on the calculated value, one or more improvement measures such as incorporating various standard/non-standard tools for various lifecycle stages of the project, organizing training for the team, and spreading awareness on the use of new tools can be taken for the future projects. Further, FIG. 7 also shows remarks section when no tool is used for a particular lifecycle stage, such as Requirement analysis. The remarks may provide reasoning's for not using any tool for a particular lifecycle stage.

The method and the system described above have numerous advantages. The present invention provides an automated process of determining the usage of tools in a project, and thus, performance parameters of the project are determined. The process of automatic determination of the usage of tools saves time and effort required by the project manager, thereby reducing the effort of project management. In addition, the chances of errors and quality issues cropping up during various lifecycle stages of the project are reduced. Thus, an overall productivity gain can be achieved by implementing corrective and timely measures based on the TUI values. The present invention also facilitates a uniform method for tracking the use of tools across various units in the organization. Additionally, the present invention facilitates comparing performance of a project of one unit with its performance in another unit.

The method, the system, and the Integrated Project Management (IPM) system for determining performance parameters of a project, as described in the present invention, may be embodied in the form of a computer system. Typical examples of a computer system include a general-purpose computer, a programmed microprocessor, a micro-controller, a peripheral integrated circuit element, and other devices or arrangements of devices that are capable of implementing the steps that constitute the method for the present invention.

The computer system typically comprises a computer, an input device, and a display unit. The computer typically comprises a microprocessor, which is connected to a communication bus. The computer also includes a memory, which may include a Random Access Memory (RAM) and a Read Only Memory (ROM). Further, the computer system comprises a storage device, which can be a hard disk drive or a removable storage drive such as a floppy disk drive and an optical disk drive. The storage device can be other similar means for loading computer programs or other instructions into the computer system.

The computer system executes a set of instructions that are stored in one or more storage elements to process input data. These storage elements can also hold data or other information, as desired, and may be in the form of an information source or a physical memory element present in the processing machine. Exemplary storage elements include a hard disk, a DRAM, an SRAM, and an EPROM. The storage element may be external to the computer system and connected to or inserted into the computer, to be downloaded at or prior to the time of use. Examples of such external computer program products are computer-readable storage mediums such as CD-ROMS, Flash chips, and floppy disks.

The set of instructions may include various commands that instruct the processing machine to perform specific tasks, such as the steps that constitute the method for the present invention. The set of instructions may be in the form of a software program. The software may be in various forms, such as system software or application software. Further, the software may be in the form of a collection of separate programs, a program module with a large program, or a portion of a program module. The software may also include modular programming in the form of object-oriented programming. The software program that contains the set of instructions (program instruction means) can be embedded in a computer program product for use with a computer, the computer program product comprising a computer-usable medium with a computer-readable program code embodied therein. Processing of input data by the processing machine may be in response to users' commands, results of previous processing, or a request made by another processing machine.

The modules described herein may include processors and program instructions that are used to implement the described functions of the modules. Some or all the functions can be implemented by a state machine that has no stored program instructions, or in one or more Application-specific Integrated Circuits (ASICs), in which each function or some combinations of some of the functions are implemented as custom logic.

While the various embodiments of the invention have been illustrated and described, it will be clear that the invention is not limited only to these embodiments. Numerous modifications, changes, variations, substitutions, and equivalents will be apparent to those skilled in the art, without departing from the spirit and scope of the invention.

1. A method for determining one or more performance parameters of a project, the method comprising:
a. defining one or more lifecycle stages of the project;
b. receiving details of one or more tools being used for each lifecycle stages of the project;
c. assigning a score based on the one or more tools being used for the project, wherein assigning the score further comprises:
i. assigning a first score to each lifecycle stages of the project when a corresponding tool is used for each lifecycle stages of the project;
ii. assigning a second score to each valid lifecycle stages of the project when no tool is used for a corresponding lifecycle stage of the project;
d. automatically calculating a value based on the assigned score; and
e. determining the one or more performance parameters of the project based on the calculated value.

2. The method according to claim 1, wherein the value corresponds to a Tool Usage Index.

3. The method according to claim 1 further comprising receiving details of effort estimate required for each lifecycle stages of the project.

4. The method according to claim 1 further comprising receiving details of one or more programming languages being used for each lifecycle stages of the project.

5. The method according to claim 1 is integrated with a Project Management Platform.

6. An Integrated Project Management (IPM) system for determining one or more performance parameters of a project, the IPM system configured for:
a. defining one or more lifecycle stages of the project;
b. receiving details of one or more tools being used for each lifecycle stages of the project;
c. assigning a score based on the one or more tools being used for the project, wherein assigning the score further comprises:
i. assigning a first score to each lifecycle stages of the project when a corresponding tool is used for each lifecycle stages of the project;
ii. assigning a second score to each valid lifecycle stages of the project when no tool is used for a corresponding lifecycle stage of the project;
d. automatically calculating a value based on the assigned score; and
e. determining the one or more performance parameters of the project based on the calculated value.

7. The IPM system according to claim 6, wherein the value corresponds to a Tool Usage Index.

8. The IPM system according to claim 6 is further configured for receiving details of effort estimate required for each lifecycle stages of the project.

9. The IPM system according to claim 6 is further configured for receiving details of one or more programming languages being used for each lifecycle stages of the project.

10. A computer program product for use with a computer, the computer program product comprising a computer usable medium having a computer readable program code embodied therein for determining one or more performance parameters of a project, the computer program product comprising:
a. a program instruction means for defining one or more lifecycle stages of the project;
b. a program instruction means for receiving details of one or more tools being used for each lifecycle stages of the project;
c. a program instruction means for assigning a score based on the one or more tools being used for the project, wherein assigning the score further comprises:
i. a program instruction means for assigning a first score to each lifecycle stages of the project when a corresponding tool is used for each lifecycle stages of the project;
ii. a program instruction means for assigning a second score to each valid lifecycle stages of the project when no tool is used for a corresponding lifecycle stage of the project;
d. a program instruction means for automatically calculating a value based on the assigned score; and
e. a program instruction means for determining the one or more performance parameters of the project based on the calculated value.

11. The computer program product according to claim 10, wherein the value corresponds to a Tool Usage Index.

12. The computer program product according to claim 10 further comprising a program instruction means for receiving details of effort estimate required for each lifecycle stages of the project.

13. The computer program product according to claim 10 further comprising a program instruction means for receiving details of one or more programming languages being used for each lifecycle stages of the project.

14. The computer program product according to claim 10 is integrated with a Project Management Platform.
